(19) United States
(12) Patent Application Publication
(10) Pub. No.: US 2025/0187329 A1
(43) Pub. Date: Jun. 12, 2025

(54) RECORDING DEVICE AND CONTROL METHOD OF RECORDING DEVICE

(71) Applicant: SEIKO EPSON CORPORATION, Tokyo (JP)

(72) Inventors: Ryuji MORIYAMA, MATSUMOTO-SHI (JP); Tsutomu OZAKI, MATSUMOTO-SHI (JP); Kazuma OZAKI, OKAYA-SHI (JP)

(21) Appl. No.: 18/976,613

(22) Filed: Dec. 11, 2024

(30) Foreign Application Priority Data
Dec. 11, 2023 (JP) 2023-208165

(51) Int. Cl. B41J 2/045; B41J 11/00; B41J 25/00

(52) U.S. Cl. CPC B41J 2/04503; B41J 2/04581; B41J 11/00214; B41J 25/001

(57) ABSTRACT

A recording device including a head configured to discharge an ink of ultraviolet curing type, an irradiation unit configured to irradiate a medium with an ultraviolet ray, a carriage mounted with the head and the irradiation unit, a movement mechanism configured to perform a forward operation in which the carriage is moved in a first direction and a return operation in which the carriage is moved in a second direction opposite to the first direction, and a control unit configured to control the movement mechanism and the irradiation unit, in which the control unit causes the head to execute discharge of the ink in the forward operation, and causes at least the irradiation unit to execute irradiation in the return operation, and makes a moving speed of the carriage in the return operation higher than a moving speed of the carriage in the forward operation.

The present application is based on, and claims priority from JP Application Serial Number 2023-208165, filed Dec. 11, 2023, the disclosure of which is hereby incorporated by reference herein in its entirety.

### BACKGROUND

### 1. Technical Field

The present disclosure relates to a recording device and a control method of a recording device.

### 2. Related Art

A known recording device performs recording by causing an ink of ultraviolet curing type that cures by irradiation of ultraviolet rays to adhere to a medium. For example, JP 2012-96377 A discloses a printer in which an inkjet head that discharges an ink of ultraviolet curing type and a UV-LED unit that irradiates ultraviolet rays are mounted on a head unit, and printing is performed while moving the head unit in a main scanning direction with respect to a medium.

The viscosity of the ink of ultraviolet curing type may change depending on the temperature. Therefore, behavior of ink from when the ink of ultraviolet curing type adheres to the medium until the ink is cured by irradiation of ultraviolet rays is affected by temperature. For example, the size and speed at which ink droplets spread by gravity vary depending on the temperature. Therefore, if there is a partial temperature difference in the ink adhering to one medium, there is a concern that the recording quality is affected, such as a difference in a color development state in one medium.

### SUMMARY

One aspect of the present disclosure is a recording device including a head configured to discharge an ink of ultraviolet curing type toward a medium, an irradiation unit configured to irradiate the medium with an ultraviolet ray, a carriage mounted with the head and the irradiation unit, a movement mechanism configured to move the carriage relative to the medium, and a control unit configured to control the movement mechanism and the irradiation unit, in which the movement mechanism executes a forward operation of moving the carriage in a first direction with respect to the medium and a return operation of moving the carriage in a second direction opposite to the first direction with respect to the medium, and the control unit causes the head to execute discharge of the ink while causing the carriage to move in the forward operation, and causes at least the irradiation unit to execute irradiation while causing the carriage to move in the return operation, and makes a moving speed of the carriage in the return operation higher than a moving speed of the carriage in the forward operation.

### BRIEF DESCRIPTION OF THE DRAWINGS

FIG. 1 is a perspective view of a recording device according to an embodiment.

FIG. 2 is a plan view of the recording device.

FIG. 3 is a front view of a main part of the recording device.

FIG. 4 is a block diagram illustrating a configuration of a control system of the recording device.

FIG. 5 is a flowchart showing an operation of the recording device.

FIG. 6 is an explanatory diagram of the operation of the recording device.

### DESCRIPTION OF EMBODIMENTS

### 1. Configuration of Recording Device

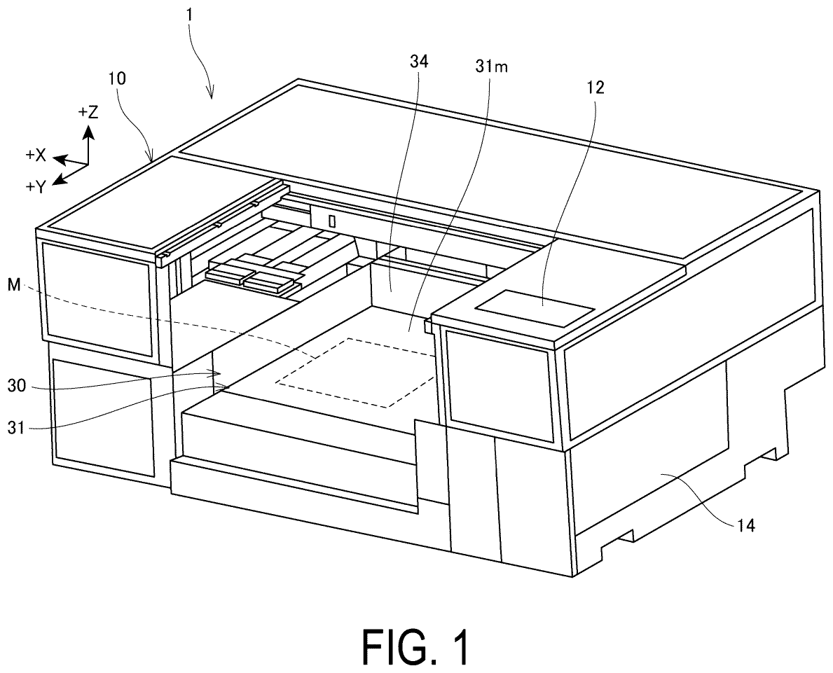

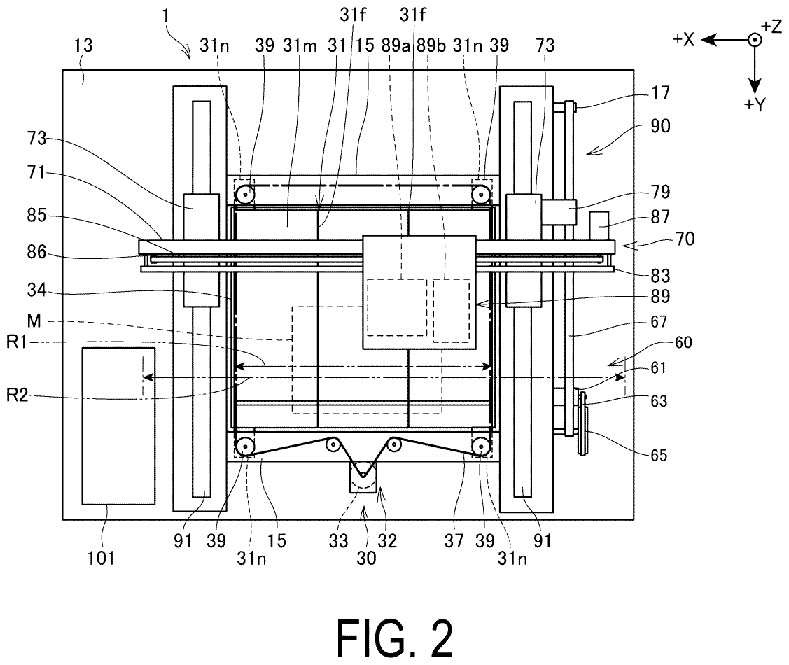

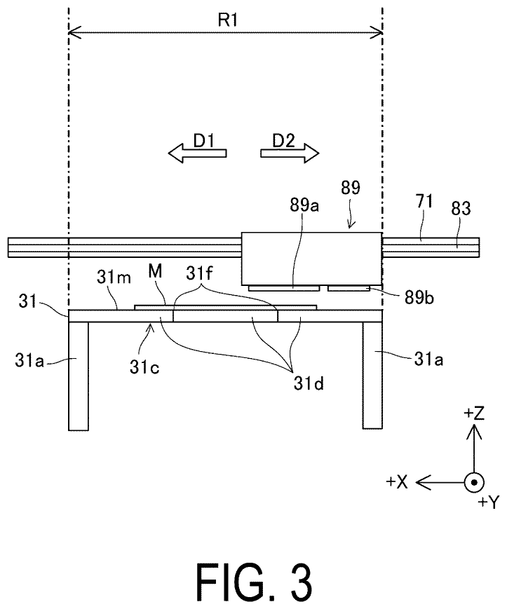

FIG. 1 is a perspective view of a recording device 1 according to an embodiment. FIG. 2 is a plan view of the recording device 1. FIG. 3 is a front view of a main part of the recording device 1, and schematically illustrates an internal structure of the recording device 1. The configuration of the recording device 1 will be described with reference to these drawings.

FIGS. 1 and 2 and FIG. 3 described later illustrate an X-axis, a Y-axis, and a Z-axis. The X-axis, the Y-axis, and the Z-axis are orthogonal to one another. The Z-axis is an axis extending in an up-down direction, and can also be called an axis extending in a vertical direction. The X-axis and the Y-axis are parallel to a horizontal plane. In the following description, a direction along the X-axis is called a left-right direction, and a direction along the Y-axis is called a front-rear direction. Specifically, a forward direction along the Z-axis is an upward direction, a forward direction along the X-axis is a rightward direction, and a forward direction along the Y-axis is a front direction.

By discharging a fluid from a recording head 89a, the recording device 1 records characters and images on a medium M. The recording device 1 can perform recording on a sheet-shaped object and a three-dimensional object having a height as the medium M. The medium M is, for example, a sheet, cloth, or a three-dimensional object. Here, the sheet refers to a sheet made of paper or a synthetic resin, and the cloth may be any of nonwoven fabric, knit, and woven fabric. Examples of three-dimensional object include adornments such as clothes and shoes, daily necessities, machine components, and various other objects.

The type of the fluid discharged onto the medium M by the recording device 1 is not limited, as long as it has fluidity. For example, the recording device 1 is a printer that ejects ink of one or a plurality of colors toward the surface of the medium M by the recording head 89a to perform color printing of characters and images on the medium M. In this case, the medium M can be called a printing medium.

In the present embodiment, the recording device 1 discharges an ink of ultraviolet curing type from the recording head 89a. By being cured by irradiation with ultraviolet rays, the ink of ultraviolet curing type is fixated to the surface of the medium M. The ink of ultraviolet curing type contains, for example, a photopolymerization initiator and a synthetic resin monomer. When this type of ink is irradiated with ultraviolet rays, the photopolymerization initiator is decomposed, and a polymerization reaction of the synthetic resin monomer is initiated to solidify the ink. The recording device 1 includes an irradiation unit 89b, and the irradiation unit 89b irradiates the ink impacted on the surface of the medium M with ultraviolet rays. The recording head 89a corresponds to an example of the head.

The recording device 1 includes a housing 10 in a substantially cuboid. A closed space is formed inside the housing 10. The housing 10 accommodates various components of the recording device 1 related to recording.

The housing 10 includes a front cover not illustrated stepping over a front surface and an upper surface of the housing 10. This front cover is attached openably/closably to the housing 10. When the front cover is opened, a medium support unit 30 is exposed, and the medium M can be installed on the medium support unit 30 and the medium M can be removed from the medium support unit 30 as described later. FIG. 1 illustrates an external appearance of the recording device 1 in a state where the front cover is removed.

A touchscreen 12 is installed on the upper surface of the housing 10. The touchscreen 12 is a device in which a display screen including a liquid crystal display panel and an organic electro luminescence (EL) panel and a touch sensor that detects a touch operation by a user are disposed in an overlapping manner.

As illustrated in FIG. 2, the recording device 1 includes a bottom plate 13 and a pair of base members 15. The bottom plate 13 is a plate-like member that supports a bottom portion of the recording device 1, and is installed on an installation surface of the recording device 1 via a leg not illustrated or the like. The base member 15 is a member extending in the left-right direction. The two base members 15 are arranged side by side in the front-rear direction on the bottom plate 13, and are fixed to the bottom plate 13.

The recording device 1 includes the medium support unit 30 that supports the medium M, a moving portion 70 that moves with respect to the medium support unit 30, and a carriage 89. The moving portion 70 mounts the carriage 89, and the moving direction of the moving portion 70 with respect to the medium support unit 30 and the moving direction of the carriage 89 are different directions. Therefore, the carriage 89 is movable in a plurality of directions with respect to the medium support unit 30, and can perform recording in a wide range of the medium M placed on the medium support unit 30. In the configuration of the present embodiment, the moving portion 70 moves in the front-rear direction of the recording device 1, and the carriage 89 moves in the left-right direction.

In the present embodiment, the medium support unit 30 is fixed to the bottom plate 13 and does not move. The medium support unit 30 includes a table 31, a fall preventive plate 34, and a height movement mechanism 32. The table 31 is disposed at a position surrounded by a pair of the base members 15 and a pair of guide shafts 91 in plan view. An upper surface of the table 31 is a rectangular flat surface, and this surface is used as a support surface 31m that supports the medium M. The table 31 corresponds to an example of the support base.

The support surface 31m is a surface on which the medium M is placed in the medium support unit 30. As illustrated in FIG. 1, the support surface 31m is exposed at the front portion of the recording device 1 in a state where the front cover is opened. In this state, the medium M can be set on the support surface 31m from the outside of the housing 10, and the medium M placed on the support surface 31m can be removed to the outside of the housing 10.

Four corners of the table 31 are provided with protrusions 31n protruding outward below the support surface 31m. The protrusion 31n supports the table 31 in the height direction. The protrusion 31n is coupled to a lifting mechanism 39 described later, and the table 31 is lifted and lowered by the operation of the lifting mechanism 39.

The fall preventive plate 34 is a plate-shaped member vertically erected so as to be in contact with the end portion of the support surface 31m. The recording device 1 includes three fall preventive plates 34 in contact with the left end, the right end, and the rear end, respectively, of the support surface 31m. The fall preventive plate 34 is erected substantially perpendicular to the support surface 31m and surrounds the support surface 31m from three sides. This can prevent the medium M placed on the support surface 31m from moving out of the support surface 31m. Thus, for example, when the medium M has a shape likely to fall or roll, the medium M can be prevented from falling out of the support surface 31m. For convenience of installation and removal of the medium M, the front end of the support surface 31m is not provided with the fall preventive plate 34, but it is of course possible to install the fall preventive plate 34 at the front end of the support surface 31m.

The fall preventive plate 34 is fixed to the bottom plate 13 or the base member 15, and abuts on or approaches the end of the support surface 31m. The fall preventive plate 34 covers from the lowest position to the highest position in the range where the support surface 31m is lifted and lowered in the height direction. Therefore, the fall preventive plate 34 can maintain a state surrounding the support surface 31m in response to lifting and lowering of the support surface 31m.

The recording device 1 includes the height movement mechanism 32. The height movement mechanism 32 includes a lifting motor 33, a lifting belt 37, and the lifting mechanism 39, and moves the table 31 up and down.

The lifting mechanism 39 includes a ball screw disposed along the vertical direction, a nut screwed to the ball screw, and a pulley. The ball screw of the lifting mechanism 39 is rotatably supported by the base member 15. The nut of the lifting mechanism 39 is fixed to the protrusion 31n of the table 31. The pulley of the lifting mechanism 39 is fixed to an upper portion of the ball screw. When the pulley of the lifting mechanism 39 rotates, the ball screw rotates, and the protrusion 31n moves along the vertical direction together with the nut in accordance with the rotation of the ball screw.

In the recording device 1, a set of the lifting mechanisms 39 including the ball screw, the nut, and the pulley is provided corresponding to each of the four protrusions 31n. That is, the four protrusions 31n are configured to be lifted and lowered by the four sets of lifting mechanisms 39.

The four sets of lifting mechanisms 39 are coupled to the lifting motor 33 via one lifting belt 37. The lifting motor 33 rotates in accordance with the control of a control unit 101 to drive the lifting belt 37 having an annular shape. The lifting belt 37 is stretched over an output shaft of the lifting motor 33 and pulleys of the four lifting mechanisms 39, and is circularly driven by the rotation of the lifting motor 33. The lifting belt 37 rotates the ball screw via the pulley of the lifting mechanism 39 to raise or lower the protrusion 31n. Since the four lifting mechanisms 39 operate in conjunction with the lifting belt 37 to lift and lower the protrusion 31n, the support surface 31m can be lifted and lowered while maintaining the level. The rotation direction of the lifting motor 33 is switched between a forward direction in which the table 31 is moved upward and a reverse direction in which the table 31 is moved downward under the control of the control unit 101.

The recording device 1 includes a drive mechanism 90 that moves the moving portion 70. The drive mechanism 90 includes the pair of guide shafts 91 and a frame drive unit 60. The guide shaft 91 is a shaft-shaped member disposed in the front-rear direction, and each of the two guide shafts 91 is disposed side by side in the left-right direction so as to step over the two base members 15. The guide shaft 91 functions as a rail that supports the moving portion 70 movably in the front-rear direction.

The frame drive unit 60 includes a frame moving motor 61, a transmission belt 63, a speed change mechanism 65, and a transmission belt 67. The frame moving motor 61 rotates in accordance with the control of the control unit 101 to drive the transmission belt 63 having an annular shape. The transmission belt 63 is stretched over between the output shaft of the frame moving motor 61 and the speed change mechanism 65, and transmits the driving force of the frame moving motor 61 to the speed change mechanism 65. The speed change mechanism 65 includes a first pulley and a second pulley, the transmission belt 63 is wound around the first pulley, and a transmission belt 67 having an annular shape is wound around the second pulley. The diameter of the first pulley and the diameter of the second pulley are different, for example, the first pulley is larger in diameter than the second pulley. The first pulley and the second pulley are coupled to a common shaft and rotatably supported by a frame not illustrated. In the speed change mechanism 65, the driving force transmitted from the transmission belt 63 to the first pulley is transmitted to the second pulley at a reduction ratio corresponding to the ratio of the diameters of the first pulley and the second pulley, and drives the transmission belt 67.

The transmission belt 67 is stretched over between the speed change mechanism 65 and a frame moving pulley 17 disposed at the rear end in the rear direction of the base member 15. The frame moving pulley 17 is rotatably supported with respect to the base member 15, and the transmission belt 67 is disposed along the guide shaft 91.

The moving portion 70 includes a main frame 71, a pair of legs 73, and the carriage 89. The main frame 71 is a plate-shaped member that is long in the left-right direction. Each of the two legs 73 is fitted to the guide shaft 91 and supported movably back and forth along the guide shaft 91. The main frame 71 is fixed across the two legs 73 and is supported from below by the legs 73. The main frame 71 is positioned above the table 31, and is positioned further above the highest position in the lifting range of the table 31.

The leg 73 supporting the left end of the main frame 71 is coupled to the transmission belt 67 via a belt coupling portion 79. When the transmission belt 67 is circularly driven by the power of the frame moving motor 61, a force for moving the leg 73 in the front-rear direction acts, and the moving portion 70 moves in the front-rear direction by this force.

The rotation direction of the frame moving motor 61 can be switched between the forward direction in which the main frame 71 is moved in the forward direction and the reverse direction in which the main frame 71 is moved in the rearward direction under the control of the control unit 101.

The carriage 89 is a substantially cuboid box, and is supported by the main frame 71 via a carriage guide shaft 83. The carriage guide shaft 83 is a shaft-shaped member fixed to the main frame 71 and extending in the left-right direction along the main frame 71, and supports the carriage 89 movably in the left-right direction. The carriage 89 is positioned above the table 31.

The recording device 1 includes a carriage driving belt 85 that moves the carriage 89, a carriage driving pulley 86, and a carriage driving motor 87. The carriage driving belt 85 is an annular belt is stretched over between the carriage driving pulley 86 and the output shaft of the carriage driving motor 87 and is arranged along the carriage guide shaft 83.

The carriage driving pulley 86 is fixed rotatably to the right end of the main frame 71. The carriage driving motor 87 is fixed to the left end of the main frame 71, rotates in accordance with the control of the control unit 101, and drives the carriage driving belt 85.

The carriage 89 is coupled to the carriage driving belt 85, and moves in the left-right direction of the recording device 1 along the carriage guide shaft 83 along with movement of the carriage driving belt 85.

The drive mechanism 90, the carriage guide shaft 83, the carriage driving belt 85, the carriage driving pulley 86, and the carriage driving motor 87 correspond to an example of the movement mechanism configured to move the carriage 89 relative to the medium M.

The carriage 89 includes the recording head 89a and the irradiation unit 89b. The recording head 89a is disposed below the carriage 89 so as to face the support surface 31m.

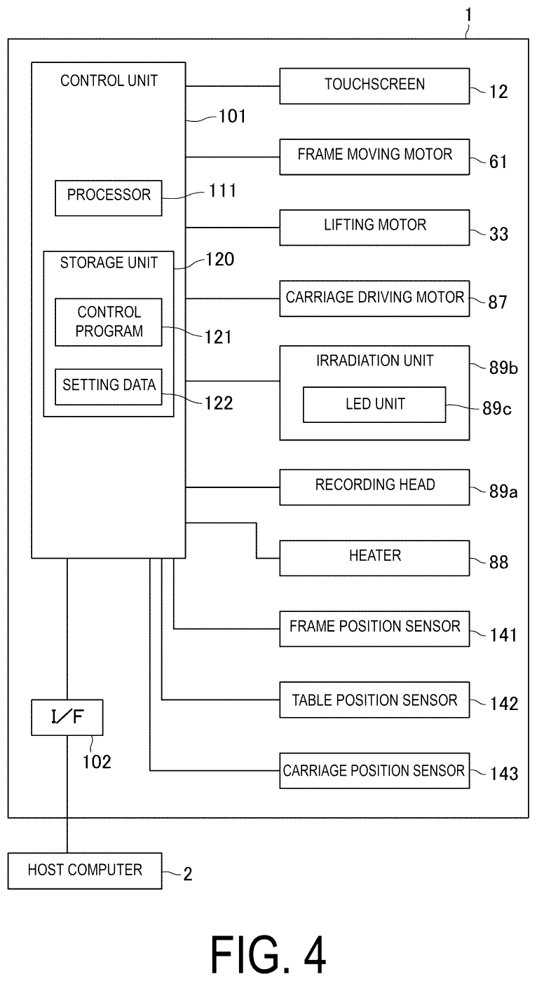

The recording head 89a includes a plurality of nozzles not illustrated opened toward the support surface 31m, and discharges ink of ultraviolet curing type from the nozzles by drive of a piezo actuator incorporated in the recording head 89a. The irradiation unit 89b is disposed below the carriage 89 so as to face the support surface 31m. The irradiation unit 89b includes a light emitting diode (LED) light source 89c (FIG. 4), and irradiates the support surface 31m with light emitted from the LED light source 89c. The LED light source 89c includes an ultraviolet LED (UV-LED) and emits irradiation light in an ultraviolet region.

When the recording device 1 performs recording on the medium M placed on the support surface 31m, the carriage 89 moves in the left-right direction along the carriage guide shaft 83, and the recording head 89a discharges ink toward the medium M during the movement of the carriage 89. Furthermore, the recording device 1 emits ultraviolet rays by the irradiation unit 89b toward the ink discharged on the medium M.

The recording device 1 includes a temperature adjustment mechanism for making the ink to have a temperature suitable for discharge, and specifically includes a heater 88 (FIG. 4). The heater 88 is mounted on the carriage 89 or the recording head 89a, or is disposed in an ink flow path outside the carriage 89. The recording device 1 may include a plurality of the heaters 88. In the recording device 1, the ink is discharged from the recording head 89a in a state of being heated by the heater 88.

FIG. 3 illustrates a range R1 and a range R2 in which the carriage 89 moves. The range R2 includes a home position provided above the support surface 31m and more outward than the support surface 31m, and is the maximum range in which the carriage 89 can move. The range R1 is a range in which recording of the medium M is possible in the range R2, and is a range in which the recording head 89a can discharge ink. For example, the range R1 matches the size in the left-right direction of the support surface 31m. The recording device 1 performs discharge of ink to the medium M and irradiation of the medium M with ultraviolet rays while moving the carriage 89 in the range R2 under the control of the control unit 101.

Here, the configuration of the table 31 and the moving direction of the carriage 89 will be described in detail.

As illustrated in FIG. 4, the table 31 includes an upper plate 31c constituting the support surface 31m and a plurality of legs 31a supporting the upper plate 31c. The upper plate 31c is, for example, a rectangular plate, and the legs 31a are erected in the vertical direction at the four corners of the upper plate 31c. The lower end of the leg 31a is fixed to the bottom plate 13 to support the upper plate portion 31c from below.

The upper plate 31c includes a plurality of members. In the present embodiment, an example in which the upper plate 31c includes three upper plate members 31d will be described. The upper plate members 31d are rectangular plates elongated in the front-rear direction of the recording device 1, and are coupled side by side in the left-right direction. Therefore, in the left-right direction of the recording device 1, a boundary between the upper plate member 31d and the upper plate member 31d appears as a joint 31f on the support surface 31m. The joint 31f is a recess on the support surface 31m. The upper plate member 31d is an example of a plurality of members constituting the table 31.

The upper plate 31c may include a fitting or the like for coupling the three upper plate members 31d.

As illustrated in FIGS. 3 and 4, the joint 31f is exposed on the support surface 31m and extends in the front-rear direction of the recording device 1. The carriage 89 moves in the left-right direction by the power of the carriage driving motor 87 together with the recording head 89a and the irradiation unit 89b. Here, as the moving direction of the carriage 89, a direction toward the +X side is a first direction D1, and a direction toward the −X side is a second direction D2. In a standby state in which the recording device 1 does not perform recording, the carriage 89 is positioned at the home position. The home position is, for example, at an end on the −X side in the range R2, and the carriage 89 moves from the home position in the first direction D1 when starting recording. Then, when the carriage 89 finishes moving in the first direction D1, the recording device 1 reverses the moving direction of the carriage 89 and moves the carriage in the second direction D2.

Movement of one time in any of the first direction D1 and the second direction D2 in the operation related to recording of the recording device 1 is called one path. The printing operation of the recording device 1 is performed in units of one reciprocation, that is, two paths, in which one path and a path in the reverse direction of the one path are combined.

More specifically, after adjusting the position of the main frame 71, the recording device 1 executes two paths without moving the main frame 71 in the front-rear direction, and performs recording. The first path can be called a forward path, and the next path can be called a return path. The recording device 1 performs discharge of ink from the recording head 89a to the medium M in the forward path, and performs irradiation of ultraviolet rays by the irradiation unit 89b in the return path. After executing the two paths, the recording device 1 moves the main frame 71, executes the following two paths, and sequentially repeats this operation, thereby performing recording in a range extending in the front-rear direction and the left-right direction.

The recording device 1 may perform discharge of the ink and irradiation of the ultraviolet rays by the irradiation unit 89b in the forward path. In the configuration illustrated in FIG. 3, the irradiation unit 89b is positioned on the −X side of the recording head 89a. Therefore, if the path of the forward path is movement in the first direction D1, the irradiation unit 89b can irradiate the ink discharged by the recording head 89a with ultraviolet rays.

Hereinafter, the recording device 1 will be described with an example of a case where the path of the forward path is the first direction D1, the path of the return path is the second direction D2, ultraviolet irradiation is performed together with discharge of ink in the path of the forward path, and ultraviolet irradiation is performed in the path of the return path. A series of operations in the path of the forward path is called a forward operation, and a series of operations in the return path is called a return operation.

The recording head 89a and the irradiation unit 89b move across the joint 31f while the carriage 89 moves in the first direction D1 and while the carriage 89 moves in the second direction D2.

### 2. Configuration of Control System of Recording Device

FIG. 4 is a block diagram illustrating a functional configuration of the control system of the recording device 1.

The recording device 1 includes the control unit 101. The control unit 101 is a computer including a processor 111 and a storage unit 120. The processor 111 includes, for example, a central processing unit (CPU) or a micro processing unit (MPU), and may include a plurality of processors.

The storage unit 120 includes a volatile memory and a nonvolatile storage unit. The volatile memory is, for example, a random access memory (RAM). The nonvolatile storage unit is configured by a read only memory (ROM), a hard disk, a flash memory, or the like.

The storage unit 120 stores a program to be executed by the processor 111 and data to be processed by the processor 111. For example, the storage unit 120 stores a control program 121 and setting data 122. By executing the control program 121, the processor 111 controls each unit of the recording device 1. When controlling recording device 1, the processor 111 uses various setting values included in the setting data 122.

An interface (I/F) 102 is coupled to the control unit 101. The interface 102 is a communication device that executes wired communication using a cable or wireless communication using a wireless communication line. The interface 102 executes communication with a host computer 2 to receive recording data. The recording data includes data of images and characters to be recorded on the medium M by the recording device 1, a command for instructing recording execution of the recording device 1, and other data.

As drive units related to recording, the frame moving motor 61, the lifting motor 33, the carriage driving motor 87, the recording head 89a, and the irradiation unit 89b are coupled to the control unit 101. The control unit 101 executes recording on the medium M by controlling these drive units.

A frame position sensor 141, a table position sensor 142, and a carriage position sensor 143 are coupled to the control unit 101. The frame position sensor 141 is a sensor that detects the position of the main frame 71 in the front-rear direction. The frame position sensor 141 may be, for example, a linear encoder provided at the guide shaft 91 or the leg 73, or a sensor that detects a rotation amount of the frame moving motor 61. The table position sensor 142 is a sensor that detects the position of the table 31 in the up-down direction. The table position sensor 142 may be, for example, a linear encoder provided at the guide shaft 91 or the leg 73, or may be a sensor that detects a rotation amount of the ball screw of the lifting mechanism 39 or a rotation amount of the lifting motor 33. The carriage position sensor 143 is a sensor that detects the position of the carriage 89 in the left-right direction. The carriage position sensor 143 may be a linear encoder disposed along the carriage guide shaft 83 or a sensor that detects a rotation amount of the carriage driving motor 87.

Specifically, the control unit 101 moves the moving portion 70 in the front-rear direction by controlling switching of the rotation direction of the frame moving motor 61 and start and stop of rotation of the frame moving motor 61. The control unit 101 moves the table 31 in the up-down direction by controlling switching of the rotation direction of the lifting motor 33 and start and stop of rotation of the lifting motor 33. The control unit 101 moves the carriage 89 in the left-right direction by controlling switching of the carriage driving motor 87 and controlling start and stop of rotation of the carriage driving motor 87. The control unit 101 causes a fluid to be discharged by operating the recording head 89a based on the recording data received by the interface 102. The control unit 101 performs recording on the medium M by the interface 102 executing these controls based on the recording data acquired from the host computer 2.

For example, by operating the lifting motor 33, the control unit 101 adjusts a gap between the support surface 31m and the recording head 89a to an appropriate size. The sensor used for gap adjustment can be mounted on the carriage 89, for example. In this case, the control unit 101 operates the frame moving motor 61 and the carriage driving motor 87, acquires a detection value of the sensor while moving the carriage 89, and performs gap adjustment.

After the gap adjustment, the control unit 101 performs recording based on the recording data. For example, while moving the carriage 89, the control unit 101 causes the recording head 89a to discharge ink onto the medium M based on the recording data, and causes the irradiation unit 89b to irradiate the medium M to which the ink adheres with ultraviolet rays. After recording is completed, the control unit 101 may operate the lifting motor 33 to move the support surface 31m to the lowest position in order to facilitate removal of the medium M.

The control unit 101 can use the detection value of the frame position sensor 141 to control the frame moving motor 61. Similarly, the control unit 101 can use the detection value of the table position sensor 142 to control the lifting motor 33, and can use the detection value of the carriage position sensor 143 to control the carriage driving motor 87.

The irradiation intensity of the LED light source 89c included in the irradiation unit 89b can be adjusted by control of the control unit 101. For example, the control unit 101 controls a power source circuit not illustrated that supplies the LED light source 89c with a current to adjust the irradiation intensity of the LED light source 89c. A specific adjustment method of the irradiation intensity is arbitrary, and examples thereof include a method of adjusting the number of LED elements that emit light among the plurality of LED elements included in the LED light source 89c and a method of performing pulse wave modulation (PWM) of the current supplied to the LED elements. The irradiation intensity of the LED light source 89c can be rephrased as a light emission intensity or a light emission amount.

The heater 88 is coupled to the control unit 101. The control unit 101 heats ink to a predetermined temperature by the heater 88. The recording device 1 may include a temperature sensor that detects the temperature of the ink together with the heater 88. In this case, the recording device 1 maintains the temperature of the ink at a predetermined temperature by operating the heater 88 based on the detection value of the temperature sensor.

The touchscreen 12 is coupled to the control unit 101. The touchscreen 12 functions as an input device that detects a touch operation and a display device that displays information. For example, when performing recording on the medium M, the control unit 101 causes the touchscreen 12 to display information regarding the recording.

### 3. Operation of Recording Device

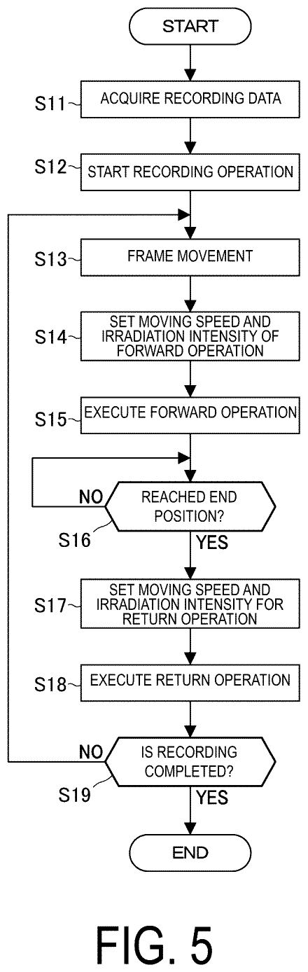

FIG. 5 is a flowchart showing the operation of the recording device 1. The operation illustrated in FIG. 5 is executed by the control unit 101.

Upon acquiring recording data from the host computer 2 (step S11), the recording device 1 starts a recording operation (step S12).

The recording device 1 moves the main frame 71 to a position suitable for recording on the medium M (step S13). With reference to the setting data 122, the recording device 1 sets the moving speed of the carriage 89 for forward operation and the irradiation intensity of the irradiation unit 89b (step S14). The recording device 1 executes the forward operation (step S15). In step S15, the recording device 1 turns on the LED light source 89c at a set irradiation intensity and emits ultraviolet rays while moving the carriage 89 at the moving speed set in step S14.

The recording device 1 determines whether or not the carriage 89 has reached the end position of the forward operation (step S16), and if the carriage 89 has reached the end position (step S16; YES), the process proceeds to step S17.

In step S17, the recording device 1 sets the moving speed of the carriage 89 for return operation and the irradiation intensity of the irradiation unit 89b (step S17). The recording device 1 executes the return operation (step S18). In step S18, the recording device 1 turns on the LED light source 89c at the set irradiation intensity and irradiates ultraviolet rays while moving the carriage 89 at the moving speed set in step S14.

The recording device 1 determines whether or not the recording on the medium M has been completed (step S19), and if the recording has been completed (step S19; YES), the present process ends. When the recording has not been completed (step S19; NO), the process returns to step S13.

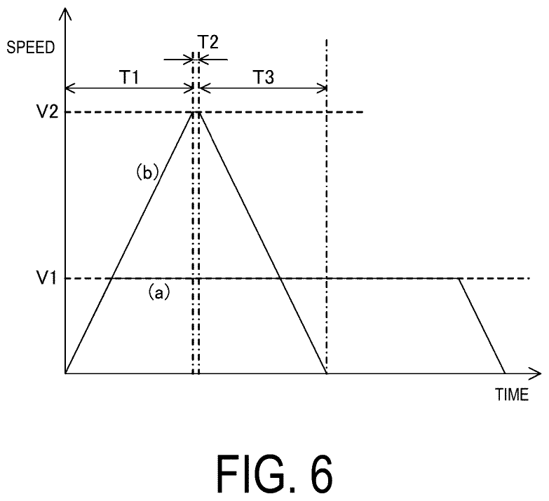

FIG. 6 is an explanatory diagram of the operation of the recording device 1, and is a table illustrating the moving speed of the carriage 89. In FIG. 6, the horizontal axis represents passage of time, and the vertical axis represents the speed of the carriage 89. FIG. 6(a) illustrates a change in the moving speed of the carriage 89 from start to stop of the forward operation, and FIG. 6(b) illustrates a change in the moving speed of the carriage 89 from start to stop of the return operation.

A speed V1 is a set value of the speed of the carriage 89 in the forward operation. A speed V2 is a set value of the speed of the carriage 89 in the return operation.

As illustrated in FIG. 6(a), in the forward operation, the carriage 89 is accelerated to the speed V1, and is moved while maintaining the speed V1 after the moving speed reaches the speed V1. Thereafter, the moving speed of the carriage 89 is decelerated toward the end of the range R1. The speed V1 can be called the maximum speed of the carriage 89 in the forward operation.

On the other hand, the target speed V2 set in the return operation is higher than the speed V1. Preferably, the speed V2 is greater than or equal to twice the speed V1. As illustrated in FIG. 6(b), since the carriage 89 is moved at a higher speed in the return operation than in the forward operation, the time for executing the return operation is shorter than the time for executing the forward operation. The speed V2 can be called the maximum speed of the carriage 89 in the return operation.

The return operation can be divided into an acceleration period T1, a constant speed period T2, and a deceleration period T3. The acceleration period T1 is a time required to accelerate the carriage 89 to the speed V2. The deceleration period T3 is a time required to decelerate the carriage 89 from the speed V2 to a stopped state. The constant speed period T2 is a time during which the carriage 89 is moved at a constant speed at the speed V2. The ratio of the constant speed period T2 to the entire return operation, that is, the sum of the acceleration period T1, the constant speed period T2, and the deceleration period T3 is, for example, 1/100 or less. As the speed V2 increases, the time required for acceleration and deceleration increases, and thus the ratio of the constant speed period T2 to the entire return operation decreases. That is, in the return operation, the speed V2 is set to be high so that the constant speed period T2 becomes 1/100 or less of the entire return operation.

When the speed V2 is high, the return operation is performed in a shorter time. That is, irradiation of the ink adhering to the medium M with the ultraviolet ray is completed in a shorter time. This suppresses the influence on the recording quality due to the temperature difference of the ink adhering to the medium M.

As described above, the table 31 includes the plurality of upper plate members 31d, and the joint 31f, which is a recess, appears on the support surface 31m. Thus, when the medium M having a sheet shape such as cut paper is placed on the support surface 31m, a part of the medium M is positioned on the joint 31f, and the other part is in contact with the plane of the upper plate member 31d. The ink discharged by the recording head 89a is heated by the heater 88, and is often at a higher temperature than the medium M on the support surface 31m. Therefore, the temperature of the ink discharged from the recording head 89a decreases after adhering to the medium M. At this time, since the heat of the ink is easily dissipated at the portion overlapping the joint 31f in the medium M, the temperature decreases faster than other parts. Therefore, in the medium M, a temperature difference of the ink occurs between the parts overlapping the joint 31f and the other parts. The temperature difference of the ink affects spread of droplets of the ink as a difference in viscosity of the ink. As a result, a difference in recording quality such as color development and sharpness occurs between the parts overlapping the joint 31f in the medium M and the other parts, and the recording quality as the entire medium M may be deteriorated.

The recording device 1 of the present embodiment increases the moving speed of the carriage 89 in the return operation. This can shorten the time from when the ink adheres to the medium M until when the ink is irradiated with ultraviolet rays, and the ink is cured in a state where the influence of the difference in viscosity of the ink is inconspicuous. Therefore, even if a difference occurs between the parts overlapping the joint 31f and the other parts, the ink can be cured while the difference is small, and the influence of the joint 31f on the recording quality can be suppressed.

The recording device 1 accelerates not the forward operation of discharging ink but the return operation. The moving speed of the carriage 89 in the return operation is preferably higher than that in the forward operation, and more preferably twice or more the moving speed in the forward operation. Therefore, the recording device 1 can accelerate curing of the ink after setting the moving speed of the forward operation to a speed suitable for discharge of the ink. Therefore, the influence on the recording quality can be suppressed to be slighter one.

Furthermore, when irradiation of ultraviolet rays by the irradiation unit 89b is performed in both the forward operation and the return operation, the irradiation intensity of the ultraviolet rays in the return operation is made equal to that in the forward operation or higher than that in the forward operation. When the carriage 89 is moved at a high speed, the return operation is completed in a short time, and therefore the time during which the medium M is irradiated with ultraviolet rays is short. When increasing the irradiation intensity of the irradiation unit 89b in the return operation, it is possible to irradiate the ink adhering to the medium M with a sufficient amount of ultraviolet rays, and it is possible to reliably cure the ink in a short time. Therefore, the irradiation intensity of the ultraviolet rays in the return operation is preferably higher than that in the forward operation.

In the forward operation, considering the influence on the ink discharged from the recording head 89a, adhesion of the ink to peripheral components of the recording head 89a, and the like, it is not easy to increase the irradiation intensity of the ultraviolet ray in the forward operation. Therefore, as in the recording device 1 of the present embodiment, for quickly curing the ink, it is effective to increase the irradiation intensity of the irradiation unit 89b in the return operation.

Furthermore, the support surface 31m is preferably made of a material having low thermal conductivity, and for example, the upper plate member 31d is made of any of synthetic resin, glass, and wood. In this case, since temperature decrease of the ink adhering to the medium M is suppressed, the influence on the recording quality can be suppressed to be slighter one.

The event related to the temperature change of the ink described above is not limited to the case where the support surface 31m has the joint 31f, and the same applies to the case where a slit or a through hole exists on the support surface 31m. The influence on the recording quality can be suppressed by applying the present disclosure also in these cases.

The above event is more slight as the recess including the joint 31f is smaller. Therefore, for example, the interval between the upper plate member 31d and the upper plate member 31d is preferably less than 1.0 mm, and more preferably, the interval between the upper plate member 31d and the upper plate member 31d is 0.7 mm or less.

### 5. Other Embodiments

The above-described embodiment is merely a specific example applied with the present disclosure. The present disclosure is not limited to the configuration of the above-described embodiment, and can be implemented in various aspects without departing from the gist of the disclosure.

In the above embodiment, the configuration in which the discharge of the ink from the recording head 89a and the irradiation of the ultraviolet ray by the irradiation unit 89b are performed in the forward operation has been exemplified, but this is an example. For example, it is of course possible to apply the present disclosure to a recording device that does not emit ultraviolet rays from the irradiation unit 89b in the forward operation and emits ultraviolet rays only in the return operation.

Other than the forward operation and the return operation described above, the recording device 1 may perform an operation of emitting ultraviolet rays by the irradiation unit 89b while moving the carriage 89.

In the above embodiment, the configuration in which the table 31 on which the medium M is placed does not move and the carriage 89 is moved along the X-axis and the Y-axis has been described as an example, but this is an example. For example, when recording is performed on the medium M, it is of course possible to apply the present disclosure to a recording device that moves the medium M along any one of the X-axis and the Y-axis and moves the carriage 89 along the other axis, and a recording device that moves the medium M along the X-axis and the Y-axis.

In the above embodiment, the joint 31f of the upper plate member 31d is exemplified as an example of the recess of the support surface 31m, but the recess may be a suction hole for sucking the medium M to the support surface 31m. That is, the recording device 1 may include a suction mechanism that sucks air from the support surface 31m, and a through hole continuous to the suction mechanism may be opened on the support surface 31m, and in this configuration, the hole opened on the support surface 31m is an example of a recess. When a screw hole for fixing the upper plate member 31d and the like and a hole for fixing a holding member for holding the medium M to the support surface 31m are formed on the support surface 31m, these holes are examples of the recess. In addition, in a configuration in which the support surface 31m has a part lower than the plane of the support surface 31m, the part can be regarded as a recess.

The configurations illustrated in FIGS. 1 to 3 and the functional configuration illustrated in FIG. 4 are examples of the recording device 1, and the application target of the present disclosure is not limited to the configurations illustrated in the drawing. For example, the recording device 1 may include components not illustrated in FIG. 4. When the operation of the recording device 1 described above is implemented by using the processor 111, it is also possible to configure a program to be executed by the processor in an aspect of a recording medium or a transmission medium that transmits the program. As the recording medium, a magnetic or optical recording medium or a semiconductor memory device can be used. The recording medium may be an internal storage device included in a server device.

The step unit of the operation illustrated in FIG. 5 is divided in accordance with main processing content in order to facilitate understanding of the operation of the recording device 1, and is not limited by the way or name of division of the processing unit. The processing unit may be divided into more step units depending on the processing content. One step may be divided so as to include more processing. The order of the steps may be changed as appropriate.

### 6. Configuration Described in Embodiment

The following configurations will be described based on the above-described embodiment.

### Configuration 1

A recording device including a head configured to discharge an ink of ultraviolet curing type toward a medium, an irradiation unit configured to irradiate the medium with an ultraviolet ray, a carriage mounted with the head and the irradiation unit, a movement mechanism configured to move the carriage relative to the medium, and a control unit configured to control the movement mechanism and the irradiation unit, in which the movement mechanism executes a forward operation of moving the carriage in a first direction with respect to the medium and a return operation of moving the carriage in a second direction opposite to the first direction with respect to the medium, and the control unit causes the head to execute discharge of the ink while causing the carriage to move in the forward operation, and causes at least the irradiation unit to execute irradiation while causing the carriage to move in the return operation, and makes a moving speed of the carriage in the return operation higher than a moving speed of the carriage in the forward operation.

According to the recording device of Configuration 1, the irradiation of the ultraviolet rays on the ink discharged toward the medium can be quickly completed. Therefore, since the ink is cured before unevenness of the state of the ink adhering to the medium expands, the influence of the temperature difference of the ink adhering to the medium on the recording quality can be suppressed.

### Configuration 2

The recording device according to Configuration 1, further including a support base having a support surface that supports the medium, in which the support surface has a recess, the carriage causes the head and the irradiation unit to face the support surface and holds the head and the irradiation unit, and the carriage moves stepping over the recess of the support surface when moving in the first direction and the second direction.

According to the recording device of Configuration 2, in the configuration in which the recess exists in the direction in which the carriage moves and the temperature of the ink discharged toward the medium is affected by the recess, the influence of the temperature difference of the ink on the recording quality can be suppressed.

### Configuration 3

The recording device according to Configuration 2, in which the support base includes a plurality of members, and the recess of the support surface is a joint of the members.

According to the recording device of Configuration 3, it is possible to suppress the influence of the joint of the members constituting the support base on the recording quality. Therefore, the recording quality can be improved in the recording device including the support base including the plurality of members.

### Configuration 4

The recording device according to any of Configurations 1 to 3, in which the control unit operates the movement mechanism such that a maximum speed of the carriage in the return operation is higher than a maximum speed of the carriage in the forward operation.

According to the recording device of Configuration 4, by making the maximum speed of the carriage in the return operation higher than that in the forward operation, irradiation of the ultraviolet ray with respect to the ink adhering to the medium can be completed in a shorter time.

### Configuration 5

The recording device according to Configuration 4, in which the control unit operates the movement mechanism such that a maximum speed of the carriage in the return operation is twice or more a maximum speed of the carriage in the forward operation.

According to the recording device of Configuration 5, by making the moving speed of the carriage in the return operation twice or more that in the forward operation, irradiation of the ultraviolet ray with respect to the ink adhering to the medium can be completed in a shorter time.

### Configuration 6

The recording device according to any of Configurations 1 to 5, in which the return operation includes an acceleration period for accelerating the carriage by the movement mechanism, a constant speed period for moving the carriage at a constant speed, and a deceleration period for decelerating the carriage, and the constant speed period is 1/100 or less of an entirety of the return operation.

According to the recording device of Configuration 6, by making the moving speed of the carriage in the return operation such a high speed that most of the movement is used for acceleration and deceleration, irradiation of the ultraviolet ray with respect to the ink adhering to the medium can be completed in a shorter time.

### Configuration 7

The recording device according to any of Configurations 1 to 6, in which the control unit causes the head to execute discharge of the ink and the irradiation unit to execute irradiation in the forward operation, and causes the irradiation unit to execute irradiation while moving the carriage at a return path speed in the return operation.

According to the recording device of Configuration 7, when performing discharge of the ink and irradiation of the ultraviolet ray in the forward operation and performing irradiation of the ultraviolet ray in the return operation, the influence of the temperature difference of the ink on the recording quality can be more effectively suppressed by completing the return operation in a short time.

### Configuration 8

The recording device according to Configuration 7, in which the control unit makes an irradiation intensity of the irradiation unit in the return operation higher than an irradiation intensity of the irradiation unit in the forward operation.

According to the recording device of Configuration 8, irradiation of the ultraviolet ray is performed so as not to affect discharge of the ink in the forward operation, and the irradiation intensity of the ultraviolet ray is increased in the return operation, whereby the ink can be more reliably cured in a short time. Therefore, the influence of the temperature difference of the ink discharged onto the medium on the recording quality can be suppressed.

### Configuration 9

A control method of a recording device including a head configured to discharge an ink of ultraviolet curing type toward a medium, an irradiation unit configured to irradiate the medium with an ultraviolet ray, a carriage mounted with the head and the irradiation unit, and a movement mechanism configured to move the carriage relative to the medium, the control method including executing, by the movement mechanism, a forward operation of moving the carriage in a first direction with respect to the medium and a return operation of moving the carriage in a second direction opposite to the first direction with respect to the medium, causing the head to execute discharge of the ink while causing the carriage to move in the forward operation, and causing at least the irradiation unit to execute irradiation while causing the carriage to move in the return operation, and making a moving speed of the carriage in the return operation higher than a moving speed of the carriage in the forward operation.

According to the control method of a recording device of Configuration 9, irradiation of the ultraviolet ray on the ink discharged by the recording device toward the medium can be quickly completed. Therefore, since the ink is cured before unevenness of the state of the ink adhering to the medium expands, the influence of the temperature difference of the ink adhering to the medium on the recording quality can be suppressed.

What is claimed is:

1. A recording device comprising:
a head configured to discharge an ink of ultraviolet curing type toward a medium;
an irradiation unit configured to irradiate the medium with an ultraviolet ray;
a carriage mounted with the head and the irradiation unit;
a movement mechanism configured to move the carriage relative to the medium; and
a control unit configured to control the movement mechanism and the irradiation unit, wherein
the movement mechanism executes a forward operation of moving the carriage in a first direction with respect to the medium and a return operation of moving the carriage in a second direction opposite to the first direction with respect to the medium, and
the control unit
causes the head to execute discharge of the ink while causing the carriage to move in the forward operation, and causes at least the irradiation unit to execute irradiation while causing the carriage to move in the return operation, and
makes a moving speed of the carriage in the return operation higher than a moving speed of the carriage in the forward operation.

2. The recording device according to claim 1, further comprising:
a support base having a support surface that supports the medium, wherein
the support surface has a recess,
the carriage causes the head and the irradiation unit to face the support surface and holds the head and the irradiation unit, and
the carriage moves stepping over the recess of the support surface when moving in the first direction and the second direction.

3. The recording device according to claim 2, wherein the support base includes a plurality of members, and the recess of the support surface is a joint of the members.

4. The recording device according to claim 1, wherein the control unit operates the movement mechanism such that a maximum speed of the carriage in the return operation is higher than a maximum speed of the carriage in the forward operation.

5. The recording device according to claim 4, wherein the control unit operates the movement mechanism such that a maximum speed of the carriage in the return operation is twice or more a maximum speed of the carriage in the forward operation.

6. The recording device according to claim 1, wherein the return operation includes an acceleration period for accelerating the carriage by the movement mechanism, a constant speed period for moving the carriage at a constant speed, and a deceleration period for decelerating the carriage, and the constant speed period is 1/100 or less of an entirety of the return operation.

7. The recording device according to claim 1, wherein the control unit causes the head to execute discharge of the ink and the irradiation unit to execute irradiation in the forward operation, and causes the irradiation unit to execute irradiation while moving the carriage at a return path speed in the return operation.

8. The recording device according to claim 7, wherein the control unit makes an irradiation intensity of the irradiation unit in the return operation higher than an irradiation intensity of the irradiation unit in the forward operation.

9. A control method of a recording device including a head configured to discharge an ink of ultraviolet curing type toward a medium, an irradiation unit configured to irradiate the medium with an ultraviolet ray, a carriage mounted with the head and the irradiation unit, and a movement mechanism configured to move the carriage relative to the medium, the control method comprising:
executing, by the movement mechanism, a forward operation of moving the carriage in a first direction with respect to the medium and a return operation of moving the carriage in a second direction opposite to the first direction with respect to the medium;
causing the head to execute discharge of the ink while causing the carriage to move in the forward operation, and causing at least the irradiation unit to execute irradiation while causing the carriage to move in the return operation; and
making a moving speed of the carriage in the return operation higher than a moving speed of the carriage in the forward operation.
